(19) United States
(12) Patent Application Publication
(10) Pub. No.: US 2026/0165382 A1
(43) Pub. Date: Jun. 18, 2026

(54) ATOMIZER FOR A VAPORIZER, AND RELATED SYSTEMS AND METHODS

(71) Applicant: Avanzato Technology Corporation, Van Nuys, CA (US)

(72) Inventors: Ryan Crowe, Lake Forest Park, WA (US); Thomas Fornarelli, Van Nuys, CA (US)

(73) Assignee: Avanzato Technology Corporation, Van Nuys, CA (US)

(21) Appl. No.: 19/408,728

(22) Filed: Dec. 4, 2025

Related U.S. Application Data
(60) Provisional application No. 63/734,793, filed on Dec. 17, 2024.

(51) Int. Cl. A24F 40/46; A24F 40/10; A24F 40/42; A24F 40/44; A24F 40/57; H05B 3/22

(52) U.S. Cl. CPC A24F 40/46; A24F 40/10; A24F 40/42; A24F 40/44; A24F 40/57; H05B 3/22

(57) ABSTRACT

An atomizer for vaporizing a liquid to be inhaled, includes two or more heaters operable to heat a liquid to a temperature at which the liquid will vaporize. The atomizer also includes two or more emitters, and two or more wicks. Each of the two or more emitters corresponds to a respective one of the two or more heaters, and is operable to release vaporized liquid as an aerosol. Each of the two or more wicks corresponds to a respective one of the two or more heaters, and is operable to convey and meter liquid toward a respective one of the two or more emitters.

### CROSS-REFERENCE TO RELATED APPLICATIONS AND INCORPORATION BY REFERENCE

This application claims priority from U.S. Provisional Patent Application 63/734,793 filed 17 Dec. 2024 and titled “Device With Multiple Coils For Vaprorizing A Fluid, And Related Systems And Methods”. This application also incorporates by this reference the entirety of this U.S. Provisional Patent Application.

### BACKGROUND

Vaporizers (vapes) are used to consume tobacco and/or other types of biomass as an alternative to smoking. Vapes work by heating an oil or other liquid of the biomass to a temperature at which the oil or other liquid will vaporize, becoming an aerosol that can then be inhaled. To do this most vapes include a reservoir to hold the oil or other liquid, an emitter where the oil or other liquid is vaporized, a heater to heat the emitter, and a wick to convey and meter the oil or other liquid from the reservoir to the emitter.

It is well understood that as a vape is used some of the oil or other liquid degrades before it can vaporized, and that often this degradation accumulates in the emitter as well as on and around the heater. This accumulation of degraded oil or other liquid, often pollutes the good oil or other liquid as it flows through the wick, and can cause the good oil or other liquid to burn by impeding its flow through the wick. This is especially true when a vape is being used for items with cannabinoids in them. Manufacturers in this instance meter the amount of oil placed in the reservoir to preserve the flavor and integrity of oils used in the device.

Many users, however, prefer a higher concentration of aerosol in the vapor that they inhale. To do this most vaporizers increase the heat generated by the vaporizer's heater to increase the amount aerosol released by the vaporizer's emitter. But, increasing the amount of heat generated by the heater, also tends to increase the rate at which oil or other liquid degrades, which adversely affects the flavor of the vaporized oil or other liquid. So, as manufacturers try to get the highest vapor-quantity-to-flavor ratio from their vaporizer, they often compromise one for the other.

Thus, there is a need for an atomizer that can generate a large amount of aerosol while minimizing the adverse effects of oil or other liquid degradation.

### SUMMARY

In one aspect of the invention, an atomizer for vaporizing a liquid to be inhaled, includes two or more heaters operable to heat a liquid to a temperature at which the liquid will vaporize. The atomizer also includes two or more emitters, and two or more wicks. Each of the two or more emitters corresponds to a respective one of the two or more heaters, and is operable to release vaporized liquid as an aerosol. Each of the two or more wicks corresponds to a respective one of the two or more heaters, and is operable to convey and meter liquid toward a respective one of the two or more emitters.

By using an atomizer that includes two or more heaters with two or more wicks and emitters each of which corresponds with a respective one of the two or more heaters, the amount of aerosol generated by the atomizer can be increased without increasing the amount of heat generated by a single heater and without increasing the volumetric flow of oil or other liquid through a single wick and emitter. This in turn minimizes the amount of oil or other liquid degradation in a single wick and emitter, which allows each of the two or more heater-wick-emitter combinations to provide a cleaner aerosol of an oil or other liquid over a longer lifespan.

In another aspect of the invention, a vaporizer for vaporizing a liquid to be inhaled, includes a reservoir to hold the liquid, an atomizer to vaporize the liquid, a chamber where the vaporized liquid (aerosol) mixes with air, and a mouthpiece to convey the mix of aerosol and air to person's mouth. The atomizer includers includes two or more heaters operable to heat the liquid to a temperature at which the liquid will vaporize, two or more emitters, each corresponding to a respective one of the heaters, and each operable to release vaporized liquid as an aerosol, and two or more wicks, each corresponding to a respective one of the heaters, and each operable to convey and meter liquid toward a respective one of the two or more emitters. The chamber holds aerosol released by the two or more emitters and allows air entering the chamber to mix with the aerosol.

In yet another aspect of the invention, a method for generating an aerosol to be inhaled, includes powering two or more heaters of an atomizer of a vaporizer. In addition to the two or more heaters, the atomizer also includes two or more emitters, each corresponding to a respective one of the heaters, and two or more wicks, each also corresponding to a respective one of the heaters. The method also includes: a) conveying, via the two or more wicks, liquid held in a reservoir of the vaporizer toward the two or more emitters; b) the two or more powered heaters vaporizing liquid conveyed by the two or more wicks; and c) releasing, via the two or more emitters, aerosol of the vaporized liquid into a chamber of the vaporizer.

### BRIEF DESCRIPTION OF THE DRAWINGS

FIG. 1 shows a cross-sectional view of a vaporizer that includes an atomizer, according to an embodiment of the invention.

FIG. 2 shows a close-up, cross-sectional, view of a portion of the vaporizer shown in FIG. 1, according to an embodiment of the invention.

FIG. 3 shows an exploded, perspective view of the portion of the vaporizer shown in FIGS. 1 and 2, according to an embodiment of the invention.

FIG. 4 shows a perspective view of one of the multiple wick-heater-emitter combinations included in the atomizer shown in FIGS. 1-3, according to an embodiment of the invention.

### DETAILED DESCRIPTION

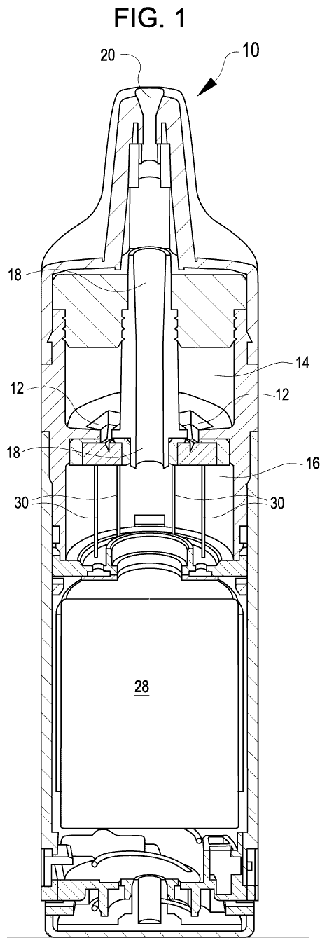

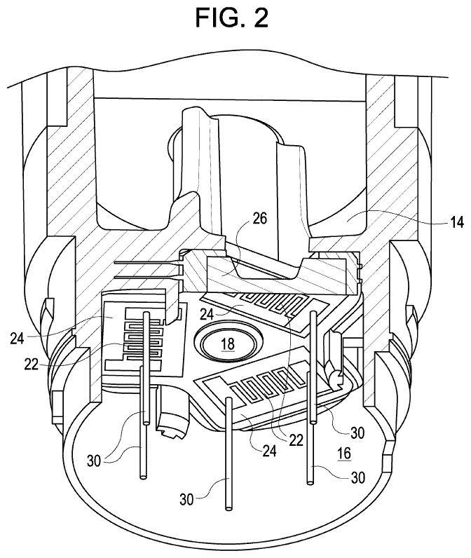

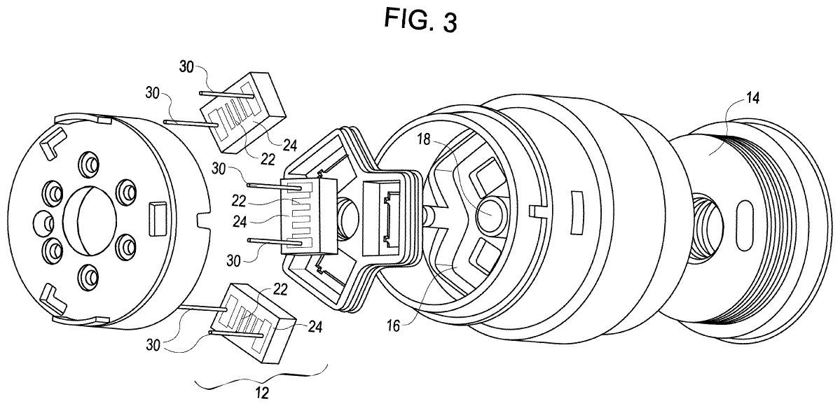

Each of FIGS. 1 and 2 shows a cross-sectional view of a vaporizer 10, that includes an atomizer 12, each according to an embodiment of the invention. FIG. 1 shows a cross-section of the whole vaporizer 10; while FIG. 2 shows a close-up, cross-sectional, view of a portion of the vaporizer 10. The atomizer 12 vaporizes an oil or other liquid to generate an aerosol of the oil or liquid that can then be consumed by a user. Here, the oil (not shown) that is vaporized is an oil that includes nicotine, but the atomizer 12 and vaporizer 10 can work with any desired oil or liquid. The vaporizer 10 also includes a reservoir 14 where oil is stored before the atomizer 12 vaporizes it, an aerosol chamber 16 that receives the vaporized oil from the atomizer 12, and a conduit 18 that directs the aerosol from the chamber 16 to a mouthpiece 20. As shown and discussed in greater detail in conjunction with FIG. 3, the atomizer 12 includes two or more heaters 22, two or more emitters 24, and two or more wicks 26. The two or more heaters 22 heat the oil to a temperature at which the oil will vaporize. The two or more emitters 24 release the vaporized liquid as an aerosol into the chamber 16, and each of the emitters 24 correspond to a respective one of the heaters 22. The two or more wicks 26 convey and meter the oil from the reservoir 14 toward a respective one of the two or more emitters 24, and each of the wicks 26 also corresponds to a respective one of the heaters 22.

In operation, a user of the vaporizer 10 turns on the heaters 22 in the atomizer 12 to heat the wicks 26 and urge oil in the reservoir 14 to flow toward the emitters 24. To generate heat, the heaters 22 receive electrical current from a battery 28 of the vaporizer 10 via leads 30. As the wicks 26 heat up, the oil located in their microstructures and in the reservoir 14 heats up. This causes the oil to become runnier and flow more easily through the wicks 26, and then into the emitters 24 where the heaters 22 heat the oil to a temperature at which the oil vaporizes to become an aerosol. In this state, the aerosol migrates into the chamber 16. As a user draws air through the mouthpiece 12, air enters the chamber 16 from below, and then flows up into the conduit 18. As the air flows through the chamber 16, the aerosol mixes with the air and flows with the air up through the conduit 18, then the mouthpiece 20, and then into a user's mouth.

By using an atomizer 12 that includes two or more heaters with two or more wicks 26 and emitters 24 each of which corresponds with a respective one of the two or more heaters 22, the amount of aerosol generated by the atomizer 12 can be increased without increasing the amount of heat generated by a single heater 22 and without increasing the volumetric flow of oil or other liquid through a single wick 26 and emitter 24. This in turn minimizes the amount of oil or other liquid degradation in a single wick-heater-emitter combination, which allows each of the two or more wick-heater-emitter combinations to provide a cleaner aerosol of an oil or other liquid over a longer lifespan.

Still referring to FIG. 1, the vaporizer 10 also includes a control board (not shown) that includes circuits for controlling different aspects and functions of the vaporizer 10. More specifically, the circuits may be used to control the amount of electrical power that the battery 28 delivers to each of the heaters 22. For example, in this and other embodiments the circuits may allow the same amount of power to be delivered to each of the heaters 22 so that each of the emitters 24 may release aerosol at the same rate. Also in this and other embodiments, the vaporizer 10 includes a single reservoir 14 that feeds oil to each of the wicks 26. In other embodiments, the vaporizer 10 may include more than one reservoir 14, such as three separate reservoirs 14, each feeding a respective one of the three wicks 26. Such vaporizers 10 can feed aerosol to a user from the three reservoirs 14 sequentially or simultaneously.

Other embodiments are possible. For example, the circuits may control separately the amount of electrical power that the battery 28 delivers to each of the heaters 22. This may be desirable when a user wants to control the concentration of the aerosol in the air/aerosol mix that he/she inhales. Sometimes a user may want a strong drag, so the user may have the battery 28 provide a large amount of electrical power to each of the heaters 22. And, sometimes a user may want a weaker drag, so the user may have the battery 28 provide less electrical power to the heaters 22. This can be accomplished by providing a reduced amount of power to each of the heaters 22 equally, or by providing more power to one or more of the heaters 22 while not providing any power to one or more of the other heaters 22.

FIG. 3 shows an exploded, perspective view of the portion of the vaporizer 10 shown in FIGS. 1 and 2, according to an embodiment of the invention. In this and other embodiments, the atomizer 10 includes three, separate wicks 26, three separate heaters 22, and three separate emitters 24, with each of the three wicks 26, heaters 22, and emitters 24, combined with a respective one of the other components to form three separate wick-heater-emitter combinations.

Each of the wicks 26, the heaters 22 and the emitters 24 may be configured as desired. For example, in this and other embodiments one or more of the wicks 26, may be configured to have two different microstructures as discussed and claimed in U.S. patent application Ser. No. 19/389,538, filed 14 Nov. 2025, and titled “Aerosol Wicks, And Related Systems and Methods”, which is incorporated by reference into this application. With two different microstructures, such a wick can quickly convey and accurately meter a variety of oils or other liquids that have different viscosities. In yet other embodiments, one or more of the wicks 26 may be any desired conventional wick. Back to the embodiments shown in FIG. 3, the heaters 22 may be any desired heater that generates heat by resisting the flow of electricity through a heating element, and the emitters 24 may be any desired conventional emitter. Moreover, each of the three specific wick-heater-emitter combinations provide the same performance in response to the same oil and electrical power inputs.

Other embodiments are possible. For example, each of the specific wick-heater-emitter combinations may be configured to provide a different performance than the remaining wick-heater-emitter combinations in response to the same oil and the same electrical power inputs. For another example, the atomizer 12 may include two or more than three specific wick-heater-emitter combinations. Also, the atomizer 12 may include less than or more than three wicks 26, and/or heaters 22, and/or emitters 24, such as a single wick 26 that corresponds with three heaters 22 and two emitters 24.

The specific wick-heater-emitter combinations may also be arranged between the reservoir 14 and aerosol chamber 16 as desired. For example, in this and other embodiments the atomizer 12 includes three wick-heater-emitter combinations that are equally spaced around the conduit 18. More specifically, each of the wick-heater-emitter combinations is clocked approximately 120 degrees from its two adjacent wick-heater-emitter combinations. In other embodiments, the three wick-heater-emitter combinations may not be equally spaced around the conduit 18.

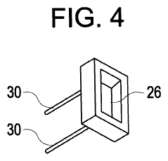

FIG. 4 shows a perspective view of one of the multiple wick-heater-emitter combinations included in the atomizer 12 shown in FIGS. 1-3, according to an embodiment of the invention. Each of the wick-heater-emitter combinations may be configured as desired. For example, in this and other embodiments each of three wick-heater-emitter combinations have the same size and geometric shape. More specifically each of the wick-heater-emitter combinations is rectangular. In other embodiments, one or more of the wick-heater-emitter combinations may have a larger size than the one or more of the other wick-heater-emitter combinations, and/or may have a different shape, such as an oval or circle.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. An atomizer for vaporizing a liquid to be inhaled, the atomizer comprising:
two or more heaters operable to heat a liquid to a temperature at which the liquid will vaporize;
two or more emitters, each corresponding to a respective one of the heaters, and each operable to release vaporized liquid as an aerosol; and
two or more wicks, each corresponding to a respective one of the heaters, and each operable to convey and meter liquid toward a respective one of the two or more emitters.

2. The atomizer of claim 1 wherein the atomizer includes three heaters.

3. The atomizer of claim 1 wherein the atomizer includes two emitters.

4. A vaporizer for vaporizing a liquid to be inhaled, the apparatus comprising:
a reservoir operable to hold a liquid;
an atomizer operable to vaporize the liquid to convert the liquid into an aerosol, the atomizer including:
two or more heaters operable to heat the liquid to a temperature at which the liquid will vaporize,
two or more emitters, each corresponding to a respective one of the heaters, and each operable to release vaporized liquid as an aerosol, and
two or more wicks, each corresponding to a respective one of the heaters, and each operable to convey and meter liquid toward a respective one of the two or more emitters;
a chamber that holds aerosol released by the two or more emitters; and
a mouthpiece operable to convey the released aerosol to a person's mouth.

5. The vaporizer of claim 4 wherein the atomizer includes three heaters.

6. The vaporizer of claim 4 wherein the apparatus includes a single reservoir that holds the liquid to be atomized by each of the atomizer's heaters.

7. The vaporizer of claim 4 wherein the apparatus includes a single chamber that holds the aerosol released by each of the atomizer's emitters.

8. The vaporizer of claim 4 further comprising control circuitry operable to power on each of the heaters independently of each other.

9. A method for generating an aerosol to be inhaled, the method comprising:
powering two or more heaters of an atomizer of a vaporizer, wherein the vaporizer's atomizer also comprises:
two or more emitters, each corresponding to a respective one of the heaters, and
two or more wicks, each corresponding to a respective one of the heaters;
conveying, via the two or more wicks, liquid held in a reservoir of the vaporizer toward the two or more emitters;
the two or more powered heaters vaporizing liquid conveyed by the two or more wicks;
releasing, via the two or more emitters, aerosol of the vaporized liquid into a chamber of the vaporizer.

10. The method of claim 9 wherein powering two or more heaters includes powering three heaters.

11. The method of claim 9 wherein powering two or more heaters includes powering each of the two or more heaters independently.

12. The method of claim 9 wherein conveying, via the two or more wicks, liquid held in a reservoir of the vaporizer toward the two or more emitters, includes conveying, via the two or more wicks, liquid held in a single reservoir of the vaporizer toward the two or more emitters.

13. The method of claim 9 wherein releasing, via the two or more emitters, aerosol of the vaporized liquid into a chamber of the vaporizer, includes releasing, via the two or more emitters, aerosol of the vaporized liquid into a single chamber of the vaporizer.
